(19) United States
(12) Patent Application Publication
(10) Pub. No.: US 2009/0253445 A1
(43) Pub. Date: Oct. 8, 2009

(54) INTELLIGENT MESSAGE MEDIATOR

(76) Inventors: Sonny Bettis, Lawrenceville, GA (US); Ian Moraes, Suwanee, GA (US); Jon S. Plotky, Atlanta, GA (US)

Correspondence Address: SMITH FROHWEIN TEMPEL GREENLEE BLAHA, LLC, Two Ravinia Drive, Suite 700, ATLANTA, GA, 30346, US

(21) Appl. No.: 12/399,004

(22) Filed: Mar. 5, 2009

Related U.S. Application Data
(63) Continuation-in-part of application No. 12/335,967, filed on Dec. 16, 2008.
(60) Provisional application No. 61/034,133, filed on Mar. 5, 2008.
(60) Provisional application No. 61/028,596, filed on Feb. 14, 2008.

(51) Int. Cl. H04W 4/12; G10L 15/26

(52) U.S. Cl. 455/466; 704/235; 704/E15.043

(57) ABSTRACT

An Intelligent Message Mediator (IMM) provides a system and method for the delivery of multiple types of messages, voice mail or otherwise, regardless of format, to subscribers of mobile communication platforms. Advantageously, an IMM is administered through a system that is operable to be retrofitted into existing mobile communication platforms. The basic concept of an IMM first provides for the receipt of pushed digital content originating from existing. Once pushed digital content is received by the IMM, the platform then converts the content into a convenient, predetermined format, as dictated by IMM subscriber preferences and forwards the converted content out to a subscriber's device. Optionally, an IMM can intelligently and automatically read and respond to content through the operation of subscriber configured intelligent assistant functions without ever having to push the content out to the subscriber. Also, some embodiments of an IMM may enable a subscriber to reply to a message content by providing a way to enable time-shifted voice messaging, participate in interactive advertising applications, dictate the delivery of prerecorded content, or specify an automatic response to a message on the subscriber's behalf.

### CROSS-REFERENCE TO RELATED APPLICATIONS

This application is being filed under 35 USC 111 and 37 CFR 1.53(b) and claims the benefit of the filing date of the United States Provisional Application for Patent that was filed on Mar. 5, 2008 and assigned Ser. No. 61/034,133. This application also is a continuation-in-part of the United States Non-Provisional Application for Patent which was filed on Dec. 16, 2008 and assigned Ser. No. 12/335,967, which application claims the priority of United States Provisional Application for Patent that was filed on Feb. 14, 2008 and assigned Ser. No. 61/028,596, both of which are hereby incorporated by reference. This application incorporates by reference U.S. Pat. No. 7,197,121 issued on Mar. 27, 2007.

### BACKGROUND OF THE INVENTION

With the continued emergence of new and more efficient means of communication, the use of today's voice message technologies will likely continue to decline. To combat the corresponding market erosion, operators seek to enhance the value of voice mail through the provision of voice mail extensions such as push messaging (pushing voice messages out to devices) and graphical user interfaces (GUIs) designed to simulate common email experiences. In an age where there are multiple competing forms of communication (SMS, IM, email, voice, video), however, more features are needed beyond push messaging and email-like clients. To help users truly improve efficiency, operators must offer solutions for processing large numbers of received messages as well as enable subscribers to communicate with each other on a selective basis.

Although the voice mail platforms for a number of voice mail suppliers support a push voice mail application or a client email-like application, the applications themselves are typically narrow in terms of function. Further, the applications known in the market tend to provide limited potential for feature expansion beyond current functionality, do not support semi-synchronous voice messaging, and require proprietary client application downloads. Not surprisingly, some operators have questioned the purpose and value of a simulated email interface for voice mail users arguing that the added burden of managing yet another client application outweighs the benefits to the subscriber. Moreover, as current voice mail applications do not significantly enhance the role of voice messaging in a subscriber's multi-tasked environment, employing such applications often results in a subscriber being overloaded with messages and other competing methods of communication.

One proposed technique to overcome the shortfalls of current message applications has been to employ a rich client on the mobile platform, such as a cellular telephone, to process messages pushed to the device. This technique, however, has proven to be problematic in that a subscriber has to download the client to the device in order to implement the technique. Inevitably, some devices may not support the particular client sought to be downloaded. Therefore, to universally offer a means for such a technique, it is a given that multiple client versions must be developed in order to support various device types.

Alternatively, some services simply push messages, such as voice mail, in the form of pseudo synchronous communications. Unfortunately, few devices are equipped to manage the multiple messages and message types that are generated from such an approach.

Therefore, what is needed in the art is a system and method for the delivery of multiple types of messages, voice mail or otherwise, regardless of format, to subscribers of mobile communication platforms.

### BRIEF SUMMARY OF THE INVENTION

An Intelligent Message Mediator (IMM), as well as features and aspects thereof, is directed towards providing a solution for the delivery of multiple types of messages, voice mail or otherwise, regardless of format, to subscribers of mobile communication platforms. Advantageously, an IMM is administered through a system that is operable to be retrofitted into existing mobile communication platforms, thus it can be an attractive technology for existing communications operators.

The basic concept of an IMM first provides for the receipt of pushed voice messages, or other content, originating from existing platforms. Once pushed messages, for example, are received by an IMM, the platform then converts the messages into a convenient, predetermined format, as dictated by user preferences, and forwards each message out to a user's device. Optionally, an IMM can intelligently and automatically read and respond to messages through the operation of user configured intelligent assistant functions without ever having to push a message out to the user. Also, some embodiments of an IMM may enable a user to reply to a message by providing a way to enable time-shifted voice messaging, participation in interactive advertising applications, dictating the delivery of prerecorded content, or specifying an automatic response to a message on the user's behalf.

In some embodiments of an IMM, users are given access to a simple interface for delivering messages to their preferred device and for automatically replying to voice messages. Further and advantageously, operators employing embodiments of an IMM can use the system to deliver messages to a user's device that may originate from entirely separate and proprietary platforms as the underlying protocols specific to various networks are not limiting to an IMM. Additionally, typical embodiments of an IMM enable end users to deliver and receive messages from a single device via multiple means and formats, such as, but not limited to, SMS, MMS, video, picture, audio, etc.

### BRIEF DESCRIPTION OF THE SEVERAL VIEWS OF THE DRAWING

FIG. 1 is a schematic drawing of a communications system that includes an Intelligent Message Mediator.

FIG. 2 is a flow diagram depicting the methodology of one embodiment of an Intelligent Message Mediator.

FIG. 3 is a general block diagram illustrating a hardware/system environment suitable for various embodiments or implementations of the IMM or aspects or components thereof.

### DETAILED DESCRIPTION OF THE INVENTION

An Intelligent Message Mediator, as well as features and aspects thereof, is directed towards providing a solution for the delivery of multiple types of messages, voice mail or otherwise, regardless of format, to subscribers of mobile communication platforms.

A solution to the aforementioned problems and issues is proposed through an evolutionary system and method for voice mail operators called an Intelligent Message Mediator (IMM). Advantageously, an IMM is administered through a system that is operable to be retrofitted into existing mobile communication platforms, thus it can be an attractive technology for existing communications operators.

The basic concept of an IMM first provides for the receipt of pushed voice messages originating from existing platforms (such as those of Comverse, Lucent, and Movius). Once pushed messages are received by the IMM, the platform then converts the messages into a convenient, predetermined format, as dictated by user preferences, and forwards each message out to a user's device. Optionally, an IMM can intelligently and automatically read and respond to messages through the operation of user configured intelligent assistant functions without ever having to push a message out to the user. Also, some embodiments of an IMM may enable a user to reply to a message by providing a way to enable time-shifted voice messaging, participate in interactive advertising applications, dictate the delivery of prerecorded content, or specify an automatic response to a message on the user's behalf.

In some embodiments of an IMM, users are given access to a simple interface for delivering messages to their preferred device and for automatically replying to voice messages. Further and advantageously, operators employing embodiments of an IMM can use the system to deliver messages to a user's device that may originate from entirely separate and proprietary platforms as the underlying protocols specific to various networks are not limiting to an IMM. Additionally, typical embodiments of an IMM enable end users to deliver and receive messages from a single device via multiple means and formats, such as, but not limited to:

1) Receive a text message via Short Message Service (SMS) with selective message metadata (e.g., sender identity, priority status, etc.) such that the user can conveniently initiate a voice call using a link embedded in the message.

2) Receive SMS with selective message metadata and web line for playing message and changing preferences.

3) Receive voice message in text form via SMS.

4) Receive SMS with notification of intelligent, automated action taken by the IMM on behalf of the user, based on user defined preferences, in response to a message.

5) Deliver voice message in text form via email (e.g., Simple Mail Transfer Protocol).

6) Deliver SMS message via an email format.

7) Deliver message in Multimedia Messaging (MMS) format.

As a more specific example, various embodiments may include a key word only delivery mechanism. For instance, if an originally delivered voice message is then converted to text and delivered via SMS, the message may be too large for SMS delivery or, there may simply be a desire to shorten the message. This feature operates by delivering only the essence of the message by identifying and delivering only key words of the voice message. Thus, the essence of a message can be delivered in a short SMS message.

As mentioned prior, some embodiments of an IMM are operable to intelligently and automatically read and respond to messages through the operation of user configured intelligent assistant functions. For example, an IMM user can configure an intelligent assistant to automatically respond to emails based on rules and/or preferences. Such rules and/or preferences may be user-defined, commercially defined, purchasable, downloadable or otherwise attainable. Users can also reply to a user's message supporting time-shifted voice messaging which is emerging as an important mode of voice communication. Pushed messages can be optionally purged periodically from originating messaging platforms.

An advantage for operators is that an IMM easily integrates into existing mobile telecommunications platforms. An operator seeking to employ an IMM need not replace or change their existing voice mail platform in order to take advantage of an IMM's features.

Further, unlike existing voice message systems that are unique to individual operator platforms, an IMM affords broad device support because there is no requirement that a specific client be downloaded to user devices. Users with devices that only support basic SMS and voice functions, for example, can benefit from the advanced functionalities of an IMM based service. Also, users with more capable devices can benefit from additional advanced IMM features such as message pushing. Further, an even richer messaging experience can be provided by an IMM based service to users of advanced devices via a web based GUI.

Advantageously, an IMM may be operable to push targeted advertising ahead of a queued voice message. In this way, the costs of an IMM based service to an end user can be mitigated as the advertising revenues to an IMM operator can be used to subsidize the service. For example, in some embodiments of an IMM, a short advertisement can be pushed to an end user before the user is given access to a voice message. When the user “calls in” to the IMM service in order to listen to a queued voice message, for example, the IMM could play a predetermined advertisement before allowing the user to access the waiting voice message. The advertisement, or pool of advertisements, may be the same for all users of the IMM service or, alternatively, the advertisement, or pool of advertisements, may be customized according to any number of statistics associated with the particular user.

More specifically, as to advertisement customization, some IMM embodiments with an advertisement aspect may be operable to support interactive, targeted advertisement-based applications that leverage existing subscriber relationships. As a non-limiting example of an interactive, targeted advertisement application used to leverage an existing subscriber relationship, consider an IMM user having an active service contract with the IMM operator that encompasses only a basic package of services accessible by a second generation (2G) device. When such a user communicates with the IMM in order to access his queued voice messages, the operator could take the opportunity to pitch the virtues of a third generation (3G) device and the advanced services available to users of that device. The user could then order an upgrade to a 3G device and the corresponding services before ever accessing his queued voice message on the IMM. A variation of the interactive advertisement customization aspect could be used to support interactive advertising by accepting responses (such as via SMS). Thus, a pushed message may include a link associated with an advertisement that, when selected, may invoke an SMS request for additional information, varied information, etc. Importantly, the advertising feature is offered herein as an example of the broad functionality of an IMM yet may, or may not, be an aspect of an IMM embodiment. The presence (or lack thereof), form, methodology, or content of an IMM advertising aspect, therefore, should not be considered as a factor for limiting the scope of the IMM.

While various embodiments of an IMM have, thus far, been primarily described relative to voice messaging services, it should be understood that embodiments may be extended beyond voice mail to include other message media such as, but not limited to, video, pictures, or instant messaging. Further, some embodiments may be operable to leverage such data as presence and location in order to determine a user's device type. Identification of a user's specific device type may, for example, be useful in an effort to deliver more targeted advertisements for opt-in subscribers. Moreover, depending on a specific user's device capabilities, the features associated with an IMM solution may be integrated into client applications residing on the device.

Another aspect specific to some embodiments of an IMM is referred to herein as the ICEBot. An ICEBot is an automated function in an IMM that affords a user the ability to deliver pre-recorded content. This aspect of an IMM includes intelligent modules that help perform tasks for a user—such as a virtual assistant. User instructions to the ICEBot aspect can be delivered via a variety of techniques including, but not limited to, SMS, web config, voice, or video. For example, one embodiment may simply require that a user send a simple text message to the operator platform instructing the IMM to “out dial” a number and play a specific audio or video message that has been previously recorded by the user. Such functionality may be useful to a salesperson who desires to send a verbal product description to a customer from whom the salesperson received a voice message. Using an IMM that has an ICEBot aspect, the salesperson in the example could text a message to the IMM, or possibly select an option from a menu when communicating with the IMM, which in turn “out dials” to the customer.

The ICEBot aspect of an IMM embodiment may also be operable to analyze a received message, such as, but not limited to, an email, text or voice message, in order to evaluate the content through algorithmic dictionary lookups, speech recognition, etc. and, based on the analyzed content, or a portion thereof, take specific actions. In this way, a user could store deliverable content in a directory on the system such that the desired content could be easily distributed to others, either automatically by the IMM according to predefined user configurations or pseudo automatically by the user on a case by case basis. More specifically, automatic distribution of content may require the IMM with an ICEBot aspect to receive a message from a party, analyze the message to determine that it includes a request for content, and deliver the requested content in a default format and manner that was either preselected by the user, identified in the request, or otherwise specified. As non-limiting examples, requested content could be delivered as a voice message through a voice call, a text message through an email, a video message through a video call, or an SMS message with a link to a voice stream or a video stream.

An IMM with an ICEBot aspect may use a special directory for storing content that a user may designate for automatic delivery. Moreover, multiple directories may also be used to organize and manage predetermined content. Access to content stored in a directory may be restricted based on a variety of manners, such as requester information (email address, telephone number, name), password and user ID information included in the message, non-user criteria such as time of day, location of origination of request, day of the week, pending the occurrence of an event, etc. Thus, in an embodiment of an IMM with an ICEBot aspect, the IMM may push a message to a device and a filter, based on various parameters such as, but not limited to, those outlined above.

A specific example of the ICEBot aspect of an IMM embodiment that pushes content not necessarily associated with a specific user, can be illustrated in the following example of a shopping assistant. The ICEBot aspect of an IMM embodiment, in addition to pushing a specific user's prerecorded content, may provide multiple ways for a shopping assistant (user) to generate price comparison information while shopping. In the example, a user seeking price comparison data sends an SMS to the IMM that includes an item's UPC code as well as the current zip code in which the user is positioned (or some other geographic identifier). Moreover, if the client device is so equipped, the video camera or DTMF keypad therein can be used to record the barcode on a product or enter the appropriate Zip code. Alternatively, a picture of the barcode can be taken and sent to the IMM using MMS. Regardless of the chosen input method, the user may receive a reply SMS/MMS message from the IMM that contains the relevant information for various shopping locations, similar products, product ratings, reviews, recall notices, etc. It should be noted that this aspect can either be implemented in a clientless manner through a video call or via a client application residing on the user device. Also, the ICEBot queried contents of the SMS could be configured by a sub (or operator) and, logically, supported by advertisements. Other examples of IMM pushed content that is not necessarily associated with a specific user, may include playing a message about a found dog, a car for sale, or a real-estate pool. Also, specific speech terms from a random user “calling in” to the IMM may be used as triggers for the delivery of various content.

To further the examples of the ICEBot aspect, suppose a user is shopping for a product having numerous alternatives available, such as a computer or a video camera. The UPC code for a specific product example can be obtained by a user with a device and forwarded to the IMM (i.e., via video of barcode, SMS of UPC code, picture of item embedded in MMS, etc.). The IMM, in turn, may query the appropriate directories and identify the price of the product at different area stores. The subsequent response to the user with the queried data may also include a relevant web link, such as, but not limited to, the GOOGLES FROOGLE service. Further, the stores queried may be selected based on price, location, user preference (such as favorite stores the user frequents), etc.

Even further, as a marketing tool, a marketer can record a video advertisement and then broadcast the video message to multiple mail recipients via a message me service. For example, a real-estate agent or broker may list a new house on the market. The agent can record a video of the house and then send the video to a list of recipients. The list can be selected on various criteria including known preferences about the recipients, interest shown, etc. In addition, the list can be dynamically generated via various detection means and forwarded to the targeted recipients identified to be in the area. Also, a database can be searched based on certain criteria that may correspond to features or information about the new listing with a targeted recipient list subsequently generated.

A massive variety of information may be sent through, and processed by, various embodiments of the IMM. For instance, a user of some IMM embodiments may select RSS or ATOM syndication sources and have updates from those sources delivered by the IMM to their device via SMS, MMS, voice call with audio, video call, SMS with links, etc. The user could use a web service or website to select the sources, set filtering rules, set frequency of update and interval rules and, in general, completely control the content that is delivered to their device.

Such an aspect of some embodiments of an IMM includes the delivery of content, such as RSS/Atoms via SMS, MMS, video calls, audio calls, etc. In essence, similar to a MYRSS cite, such an aspect allows a user to subscribe to RSS feeds, or ATOMS, and then specify the delivery of the associated content via an alternate means, such as SMS, MMS, video phone call or audio phone call. As described prior, the IMM is operable to receive content in various forms, convert the content to a form predefined by the user, and then either forward the content or store the content for later review. Thus, the aspect of the IMM currently being described enables a user to select an RSS or ATOM syndication source and have updates from the source delivered to a specified device via SMS, MMS or other method. The user may employ a website to select the sources, set filtering rules, set frequency of update and interval rules and, in general, completely control the content that is delivered to a device. Further, content may be delivered in accordance with U.S. Pat. No. 7,197,121 which is incorporated herein by reference.

Another aspect of some IMM embodiments is a video portal. A video portal aspect of an IMM provides users a web tool for the creation of their own personal mobile video portal. Users employing such an aspect can use a web interface to create their portal and upload content and/or record video messages. Similar to users of the voice messaging aspects of IMM embodiments, users of a video portal aspect could access and manage content via a video device.

More specifically, the web tool anticipated above would enable a user to create a personal video portal, upload video content, organize the content, control the content and develop the content. For instance, the content could be controlled by defining the size of the video screen, the quality of playback, etc. The tool may also allow a user to drag and drop content into, or onto, the video portal through a web browser. The web tool could also allow a user to customize the mobile device interface through the web browser. Further, a window may be available to demonstrate how the content will be rendered on a mobile device. Thus, the entire portal, links, content, etc. could be controlled and modified using a web browser and, the manner in which it will appear on a mobile device could be observed and modified. It will be appreciated that the content may also be delivered to other destinations rather then just a mobile device and other non-limiting examples include PC's, TVs (IPTV or digital TV), etc.

Other embodiments of an IMM may also include an audio portal. A user of an audio portal could configure a list of stories to be heard, designate content to be converted from text to voice, or define keys to select and control the playback of content (such a feature could also apply to the previously described video portal aspect). Subsequent access to content provided through an audio portal aspect may be available through an audio call to the IMM.

Yet another feature for some embodiments of an IMM is the provision of content channels. Advantageously, content channels may provide users of an IMM efficient access to stored content by reducing the number of keystrokes required to access and view the content. For example, a user of an IMM with a content channel aspect may call a number and, upon the call being answered by the IMM, enter a key sequence that connects the user to a specific type of content (e.g., a specific traffic cam, a specific video feed, etc.).

Turning now to the drawings in which like labels represent like elements throughout the drawings, various aspects, features and embodiments of the present invention will be presented in more detail. The examples set forth in the drawings and the detailed description, are provided by way of explanation of the invention and are not meant as limitations of the invention. The present invention thus includes any modifications and variations of the following examples as come within the scope of the appended claims and their equivalents.

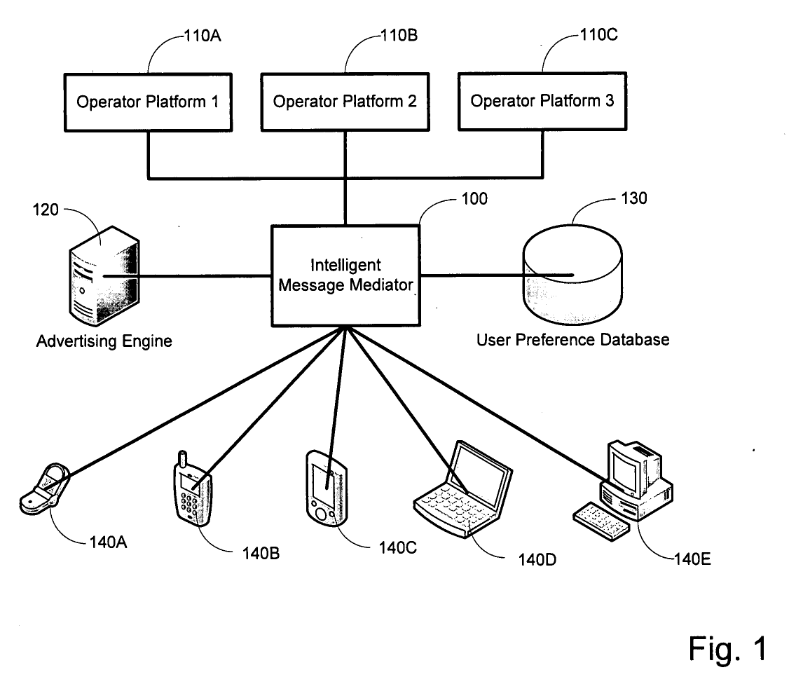

FIG. 1 is a schematic drawing of a communications system that includes an Intelligent Message Mediator 100. As was described prior, an advantage of the IMM is that it can be employed by operators of various communications platforms 110A-C. The IMM 100, in its various embodiments, is operable to receive digital content from communications platforms 110A-C running disparate protocols. In one embodiment of the IMM 100, a user of any one of the communications platforms 110A-C may forward digital content to a subscriber 140A-E of an IMM 100 service. Advantageously, the IMM 100 receives the digital content and, according to rules and definitions within the user preference database 130 predetermined by the subscriber 140A-E, converts the digital content into a preferred format. Once converted, the IMM 100 may forward the digital content directly to the subscriber 140A-E or notify the subscriber 140A-E that the converted digital content is available for retrieval.

Notably, IMM 100 service subscribers 140A-E may access the IMM 100, and any content associated therein, via numerous digital devices with various capabilities for viewing content formats including, but not limited to cell phones (all generations), personal digital assistants, navigation devices, and computers. Also, as previously described, various embodiments of an IMM 100 may be operable to also receive content from subscribers 140A-C with instructions to push the content to non-subscribers, other subscribers, or a combination thereof. Further, some embodiments of an IMM 100 may communicate with an advertising engine 120 for the purpose of storing and pushing advertising content to subscribers 140A-E ahead of content specific to a subscriber 140A-E.

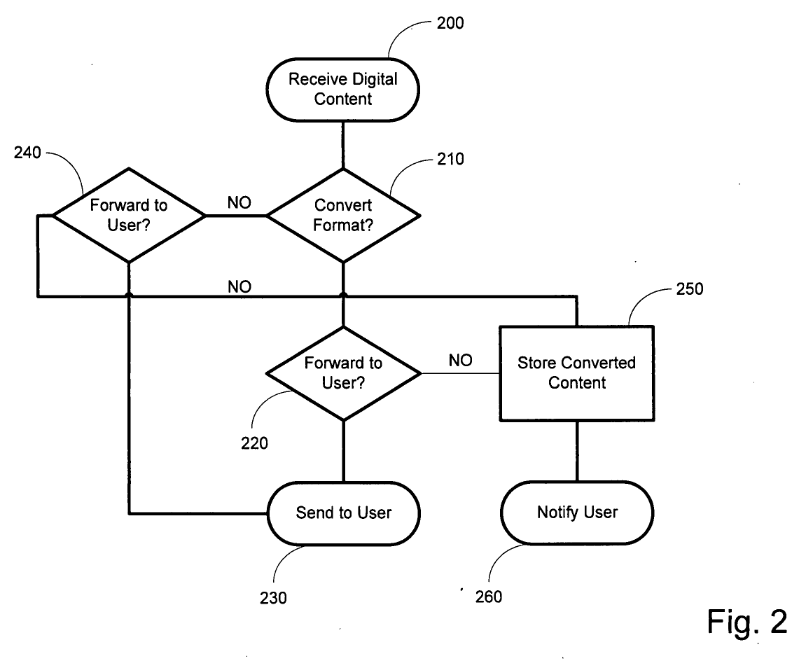

FIG. 2 is a flow diagram depicting the methodology of one embodiment of an Intelligent Message Mediator. As described prior, an IMM 100 may receive content 200 from most any source and in most any format before it is converted to predefined formats preferred by its subscribers. The exemplary methodology depicted in FIG. 2 shows digital content received 200 by the IMM 100. Once received, the IMM 100 determines the subscriber 140A-E, or subscribers, to whom the content is directed. Once the target subscribers 140A-E are identified, the IMM 100 next determines whether the format of the content must be converted 210 to meet the subscriber predefined preferences 130. If required, the IMM 100 converts the format and determines whether the subscriber to whom the content is directed has opted to have content forwarded directly 220. If yes, then the converted content is forwarded to the subscriber 230. If no, then the converted content is stored 250 and the user is notified 260 that the converted content is available.

Moving back to the original step of determining whether the received digital content 200 is in a format preferred by the subscriber 210, if content does not require conversion then the IMM 100 determines whether the content should be forwarded directly to the subscriber 230 or stored 250 for later access.

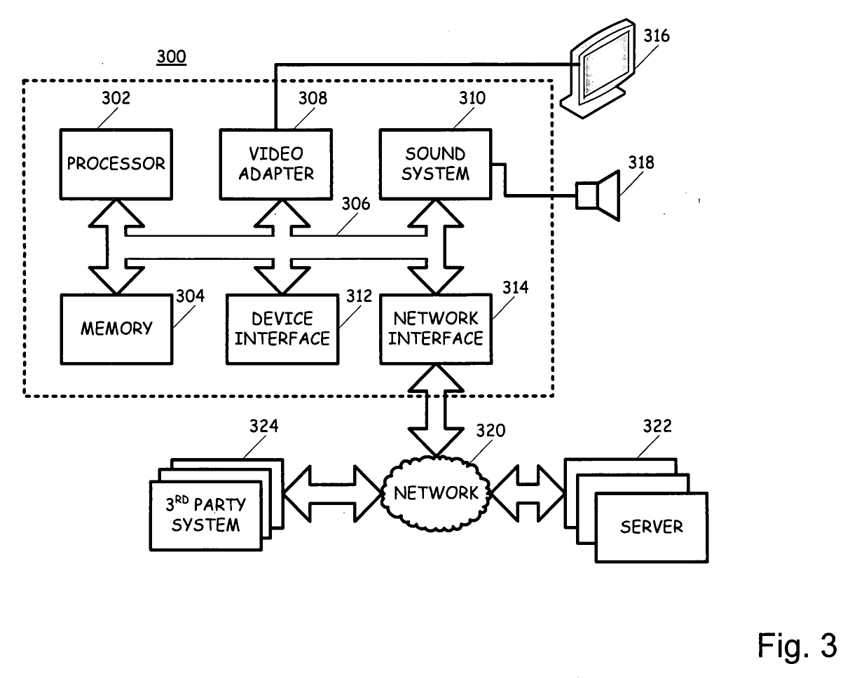

FIG. 3 is a general block diagram illustrating a hardware/system environment suitable for various embodiments or implementations of the IMM or aspects or components thereof. A general computing platform 300 is shown as including a processor 302 that interfaces with a memory device 304 over a bus or similar interface 306. The processor 302 can be a variety of processor types including microprocessors, micro-controllers, programmable arrays, custom IC's etc. and may also include single or multiple processors with or without accelerators or the like. The memory element 304 may include a variety of structures, including but not limited to RAM, ROM, magnetic media, optical media, bubble memory, FLASH memory, EPROM, EEPROM, etc. The processor 302 also interfaces to a variety of elements including a video adapter 308, sound system 310, device interface 312 and network interface 314. The video adapter 308 is used to drive a display, monitor or dumb terminal 316. The sound system 310 interfaces to and drives a speaker or speaker system 318. The device interface 312 may interface to a variety of devices (not shown) such as a keyboard, a mouse, a pin pad, and audio activate device, a PS3 or other game controller, as well as a variety of the many other available input and output devices. The network interface 314 is used to interface the computing platform 300 to other devices through a network 320. The network may be a local network, a wide area network, a global network such as the Internet, or any of a variety of other configurations include hybrids, etc. The network interface may be a wired interface or a wireless interface. The computing platform 300 is shown as interfacing to a server 322 and a third party system 324 through the network 320.

In the description and claims of the present application, each of the verbs, “comprise”, “include” and “have”, and conjugates thereof, are used to indicate that the object or objects of the verb are not necessarily a complete listing of members, components, elements, or parts of the subject or subjects of the verb.

In this application the words “unit” and “module” are used interchangeably. Anything designated as a unit or module may be a stand-alone unit or a specialized module. A unit or a module may be modular or have modular aspects allowing it to be easily removed and replaced with another similar unit or module. Each unit or module may be any one of, or any combination of, software, hardware, and/or firmware.

The Intelligent Message Mediator (IMM) has been described using detailed descriptions of embodiments thereof that are provided by way of example and are not intended to limit the scope of the invention. The described embodiments comprise different features, not all of which are required in all embodiments of the IMM. Some embodiments of the IMM utilize only some of the features or possible combinations of the features. Variations of embodiments of the IMM that are described and embodiments of the IMM comprising different combinations of features noted in the described embodiments will occur to persons of the art.

It will be appreciated by persons skilled in the art that the IMM is not limited by what has been particularly shown and described herein above. Rather the scope of the IMM is defined by the claims that follow.

What is claimed is:

1. A device for intercepting digital content sent to a subscriber of a communications service, the device being operable to:
receive digital content directed toward a subscriber;
convert said digital content into a format designated by subscriber;
forward converted digital content to subscriber's designated device.

2. The device of claim 1, wherein the converted digital content is a message in the form of a Short Message Service (SMS) containing selective message metadata related to the content sender such that the subscriber can initiate a reply message by using a link embedded in the content.

3. The device of claim 1, wherein the converted digital content is a message in SMS form that contains selective message metadata and a uniform resource locator (URL) pointing to the converted digital content.

4. The device of claim 1, wherein the converted digital content is a voice message that has been converted to text via SMS.

5. The device of claim 1, wherein the converted digital content is a voice message that has been converted to text and delivered to the subscriber as an email via Simple Mail Transfer Protocol (SMTP).

6. The device of claim 1, wherein the converted digital content is a text message in SMS format that has been converted to an email and delivered to the subscriber via SMTP.

7. The device of claim 1, wherein the converted digital content is delivered to the subscriber in Multimedia Messaging (MMS) format.

8. The device of claim 1, further operable to forward a second digital content instance to subscriber ahead of said converted digital content.

9. The device of claim 8, wherein said second digital content instance provides a means for interaction with the subscriber.

10. The device of claim 8, wherein the content of said second digital content instance is dictated by data specific to the subscriber.

11. The device of claim 1, wherein, instead of forwarding converted digital content to a subscriber's device, the device:
stores converted digital content;
notifies subscriber of stored converted digital content; and
provides subscriber access to converted digital content.

12. A device for intercepting digital content sent to a subscriber of a communications service, the device being operable to:
receive digital content directed toward a subscriber;
analyze digital content in order to identify instructional queues; and
take automatic action on behalf of the subscriber according to identified queues.

13. The device of claim 12, further operable to provide notification to said subscriber that automatic action has been taken on behalf of said subscriber.

14. The device of claim 13, wherein notification to said subscriber is in SMS format.

15. The device of claim 12, wherein said instructional queues and automatic actions are predefined by said subscriber.

16. The device of claim 15, wherein said instructional queues and automatic actions are stored in at least one subscriber specific directory.

17. The device of claim 12, wherein said automatic action on behalf of subscriber includes automatic delivery of specific content predefined by subscriber.

18. A device for forwarding digital content to a subscriber of a communications service, the device being operable to:
receive from subscriber a request for digital content;
analyze request in order to identify instructional queues;
query at least one database for requested digital content; and
forward queried digital content to subscriber in a format predetermined by subscriber.

19. The device of claim 18, wherein the request for digital content is submitted in a picture format.

20. The device of claim 18, wherein the request for digital content is submitted in a video format.

21. The device of claim 18, wherein the request for digital content is submitted in an SMS format.

22. The device of claim 18, wherein the request for digital content is submitted in an audio format.

23. The device of claim 18, wherein the request for digital content is submitted in an MMS format.

24. The device of claim 18, wherein instructional queues are derived from subscriber's geographic location.

25. The device of claim 18, wherein instructional queues are derived from statistical data associated with the subscriber.

26. A device for distributing digital content to subscribers of a communications service, the device being operable to:
receive from a subscriber a digital content to distributed;
receive from a subscriber a list of other subscribers to whom said digital content is to be distributed;
convert said digital content into formats specified by said other subscribers; and
provide converted digital content to said other subscribers per the individual specified formats of said other subscribers.

27. The device of claim 26, wherein said list of other subscribers is compiled based on statistics associated with said other subscribers.

28. The device of claim 26, wherein said list of other subscribers is specifically determined by said subscriber.

29. The device of claim 26, wherein said digital content received from said subscriber is in a video format and was generated via a web based video portal interface.

30. The device of claim 29, wherein said web based video portal interface is operable to manage and edit a library of a subscriber's video content.

31. A method for providing digital content to a subscriber of a communications service, the method comprising the steps of:
receiving digital content directed toward a subscriber;
converting said digital content into a format designated by subscriber;
storing converted digital content;
notifying subscriber that converted digital content is available for review;
providing subscriber access to converted digital content.
